(19) United States
(12) Patent Application Publication
(10) Pub. No.: US 2007/0053245 A1
(43) Pub. Date: Mar. 8, 2007

(54) Information carrier and apparatus

(76) Inventor: Martinus Wilhelmus Blum, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/557,641

(22) PCT Filed: May 13, 2004
(86) PCT No.: PCT/IB04/50667

§ 371 Date: Nov. 17, 2005

(30) Foreign Application Priority Data
May 21, 2003 (EP) 03076563.0
Oct. 14, 2003 (EP) 03103800.3

(51) Int. Cl. G11B 21/08

(52) U.S. Cl. 369/30.04

(57) ABSTRACT

The invention relates to an information carrier 10 comprising a main channel and an auxiliary channel carrying position information 21, according to which some of the least significant bits of the position information 21 are made available as local-position information 22 at a higher rate than the whole position information 21. The information carrier can be in particular an optical disk of recordable type, wherein the auxiliary channel is the wobble channel and the position information 21 is an address. An embodiment of the invention is described of an optical disc based on Blue-ray Disk standard. When an estimate of the current address is already available and the uncertainty only resides in some of the least significant bits, the entire address can be quickly reconstructed as soon as a repetition of the local-position information 22 is acquired. The invention further relates to an apparatus for accessing such an information carrier 10.

The invention relates to an information carrier and an apparatus.

An embodiment of an information carrier indicated above is an optical disk according to the upcoming Blu-ray Disk (BD) standard.

Such an optical disk comprises two physically distinct channels: a main channel, mainly used for comprising user-information, e.g. music, a movie, software or other user-data, and an auxiliary channel comprising position information frames, the position information frames carrying position information indicative of their own position on the disk.

During a write access this position information can be retrieved only from a position information frame present in the secondary channel, the information relevant to which is encoded in the form of a radial modulation of a track present on the disk, whereas during a read access the position information can be retrieved also from the main channel, since a replica of the position information is present therein, and considerations of convenience will dictate where the position information is actually retrieved from. In other words, retrieving the position information from the auxiliary channel is mandatory for a write access, whereas it is optional, and in some cases convenient, for a read access.

The disk can be accessed by an apparatus provided with a laser, as read-out means, for producing a laser spot on the disk. Preliminarily to every access, the apparatus, has to acknowledge the current position of the read-out means on the disk, which in this case corresponds to the position of the laser spot on the disk. The operation of acknowledging the current position will generally have to be performed several times before the access can actually be accomplished, as it is known that an access at a desired position from an arbitrary position takes place in successive approximations, and therefore it is important that it can be accomplished without an excessive time burden.

With this known information carrier and this known apparatus, retrieving the position information from the auxiliary channel requires the acquisition of an entire position information frame, implying that a portion of the groove, in the worst case, as long as a portion containing nearly two position information frames has to be scanned, if the scanning occurs to start immediately after the beginning of a position information frame.

It is a first object of the present invention to provide an information carrier which generally allows for a fast retrieval of a position of the read-out means on the information carrier.

It is a second object of the present invention to provide an apparatus for accessing an information carrier, which generally is capable of determining fast the position of the read-out means on the information carrier.

According to the invention, the first object is achieved by an information carrier as claimed in claim 1.

The invention is based on the recognition that in some circumstances an estimate of the current position of the read-out means is already available prior to the retrieval of the complete position information from the information carrier. In this way it is restricted, although not eliminated, the uncertainty about the exact current position of the read-out means.

This is the case, for example, when positioning means present in the apparatus have remained substantially still since the previous access took place, which position is known to the apparatus. In the case of an optical disk and a corresponding apparatus, it has to be outlined that, even in the case that the positioning means have remained substantially still, the exact current position can be yet uncertain due to the fact that the optical disk in the meantime has been rotating, in particular due to a phenomenon known as radial run-out. Radial run-out may be originated upon rotation of the optical disk and can be observed for example in a condition in which the positioning means are still, i.e. the laser is still in respect with the apparatus, as an alternative displacement of the laser spot across several spiral turns during a revolution of the optical disk. The radial run-out is due to the non-coincidence between the center of rotation of optical the disk and the geometrical center of the spiral groove present on the optical disk.

Further, it is recognized that, when an estimate of the current position of the read-out means is already known to an apparatus accessing the information carrier, a range of positions can be identified, wherein it is predicted that the read-out means are located. The identified range of positions can be specified, for example, as the range of positions comprised within the estimate minus a position displacement and the estimate plus the position displacement, the position displacement, which can be assessed by means of observations and calculations, being the maximum possible difference between the estimate of the current position and the actual current position, when an estimate is available.

In an information carrier according to the invention, the local-position information, which is part of the position information, is repeatedly present in the position information frames. The local-position information indicates where exactly the read-out means are located within the identified range, given the fact that they are located within the identified range, i.e. in presence of an estimate of the current position of the read-out means. Since the local-position information can be retrieved when a repetition of the local-position information is acquired and recognized, in presence of an estimate of the current position of the read-out means an information carrier according to the invention allows for the determination of the position information on the basis of the estimate and of the local-position information without requiring that the entire position information frame is acquired, and thus relatively fast.

In an embodiment of the information carrier according to the invention, the information carrier has the features claimed in claim 2. A subframe present in a frame is a portion of the frame which can be detected independently of the rest of the frame and which is carrying information that can be retrieved from the subframe independently of the rest of the frame, therefore without requiring that the frame is detected or that symbols present in the rest of the frame are acquired. The presence of the subframes carrying the local-position information allows for a simpler and faster retrieval of the local-position information, as it is sufficient to acquire a subframe to retrieve the local-position information.

In a further embodiment of the information carrier according to the invention, the information carrier has the features claimed in claim 3, so as to minimize the portion of frame that has to be scanned in order to acquire a subframe, and consequently retrieve the local-position information, in a time efficient way.

In a further embodiment of the information carrier according to the invention, the information carrier has the features claimed in claim 4. In such an information carrier, the position information frames comprise a first sync symbol and data symbols, the first sync symbol having the function to signal to decoding means for acquiring the frames the presence and the position of the frames and to synchronize their acquisition, and the data symbols embodying the position information. The presence of the first sync symbol and of the second, different, sync symbol respectively for the position information frames and for the subframes simplifies the design of the subframes and facilitates the decoding thereof and the retrieval of the local-position information.

A different aspect of the information carrier of the invention is relevant to the nature of the position information and the local-position information. In an embodiment of the information carrier according to the invention, the information carrier has the features claimed in claim 5.

Each position information frame occupies a location on the information carrier, the location being identified by an address. The position information therefore comprises the address of the location occupied by the position information frame, like for example on an optical disk of recordable type wherein the position information only consists of the address.

In a further embodiment of the information carrier according to the invention, the information carrier has the features claimed in claim 6.

The portion of the address, or in other words the number of bits, which constitutes the Least Significant Portion (LSP) of the address reflects considerations made in the design of the information carrier according to the invention.

As said before, there are circumstances in which an estimate of the current position is available prior to the retrieval of the position information. In those circumstances, an apparatus while accessing an information carrier according to the invention is able to determine the position of the read-out means by combining the local-position information retrieved from a repetition and the estimate of the current position.

The circumstances in which an estimate is made available comprise the case, for example, in which the positioning means have kept the read-out means still since the previous access, which position is known to the apparatus, and therefore the position of the previous access represents the estimate of the current position. Additionally, this could be the case also after a positioning of the read-out means towards a target position, in case the positioning action has been performed taking accurately into account the starting position and the density of data in the information carrier, especially when the positioning occurs over a range of positions small in respect with the overall range of positions present in the information carrier, also known as “short jump”, the target position in this case representing the estimate of the current position.

The number of bits included in the LSP of the address and present in the repetitions is directly related to the rate at which the local-position information is made available and to the range of situations in which the current position can actually be determined by combining the local-position information retrieved from a repetition and the estimate of the current position, instead of being retrieved after having acquired an entire position information frame.

A comparably higher number of bits implies that the local-position information gives information over a wider range of positions, therefore an estimate of the current position, together with the local-position information, can be used in a larger number of circumstances to reconstruct the current position; however a repetition will require comparably more symbols, possibly implying that a comparably lower number of repetitions can be present in a position information frame, and therefore the local-position information being made available at a comparably lower rate.

A comparably lower number of bits implies that the local-position information gives information over a tighter range of positions, therefore an estimate of the current position, together with the local-position information, can be used in a more restricted number of circumstances to reconstruct the current position; however a repetition will require comparably less symbols, possibly implying that a comparably higher number of repetitions can be present in a position information frame, and therefore the local-position information being made available at a comparably higher rate.

Experiments conducted by the applicant with an optical disk as the information carrier, aiming at reliably allowing the current positions to be determined on the basis of the estimate and of the local-position information at least when the positioning means have kept the read-out means still since the previous access, which position is known to the apparatus, the position information being the address of the position information frames, and consisting of 24 bits, have shown that a choice of six bits for the LSP of the address results in a good trade-off between the different requirements.

In another embodiment of the information carrier according to the invention, the information carrier has the features claimed in claim 7. In this case the turn number of the turn in which the position information frame is located, effectively represents a form of position information alternative to the address. The local-position information can be represented for example by the LSP of the turn number, the position information being represented by the entire turn number.

As an alternative, the local-position information can be represented by the LSP of the turn number, the position information being represented by both the address and the LSP of the turn number. The local-position information can also be represented by both the LSP of the turn number and the LSP of the address, the position information being represented by both the address and the LSP of the turn number. The portion of the turn number, or in other words the number of bits, which constitutes the turn number LSP reflects considerations made in the design of the information carrier similar to the design considerations as discussed with reference to the embodiment of the record carrier according to claim 6.

The inclusion of the LSP of the turn number in the local-position information can be particularly advantageous since it quickly gives the apparatus the information of how many tracks have to be crossed in order to reach the turn where the desired position is located, in the eventuality that the current position and desired position are adequately near one to the other.

A different aspect of the information carrier of the invention is relevant to the nature of the auxiliary channel. In a relevant embodiment of the information carrier according to the invention, the information carrier has the features claimed in claim 8, which is the case for example for optical disks of recordable type.

According to the invention, the second object is achieved by an apparatus as claimed in claim 9. Since the decoding means are able to separately retrieve a repetition of local-position information from position information frames, when an estimate of the position of the read-out means is available, the apparatus can determine the position of the read-out means as soon as the local-position information is retrieved, without having to acquire an entire position information frame, and thus earlier. The circumstances in which an estimate of the read-out means is made available can be restricted to predetermined cases, like for example the cases in which the positioning means have kept the read-out means still since the previous access.

In an embodiment of the apparatus according to the invention, the apparatus has the features claimed in claim 10. The discriminations means can flexibly decide whether the position information can be determined by using the local-position information. Therefore an estimate is made available based on various factors like for example the length of a jump occurred since the previous access and/or the presence and entity of radial run-out. If no estimate can be made available, the position information has to be retrieved by acquiring an entire position information frame.

In an embodiment of the apparatus according to the invention, the apparatus has the features claimed in claim 11, thus enlarging the set of circumstances in which the position information can be determined on the basis of the estimate of the position of the read-out means and the local-position information.

In a further embodiment of the apparatus according to the invention, the apparatus has the features claimed in claim 12.

Radial run-out is largely responsible for uncertainty on the position of the read-out means upon rotation of the disk even when the read-out means have been kept still since the last access, which position is known. In some cases the radial run-out associated to some disks may be so large that the estimate could be made unreliable and thus useless. An apparatus as claimed in claim 12 remedies for these cases, thus further enlarging the set of circumstances in which the position information can be determined on the basis of the estimate of the position of the read-out means and the local-position information.

These and other aspects of the information carrier and the apparatus according to the invention will be further elucidated and described with reference to the drawings. In the drawings:

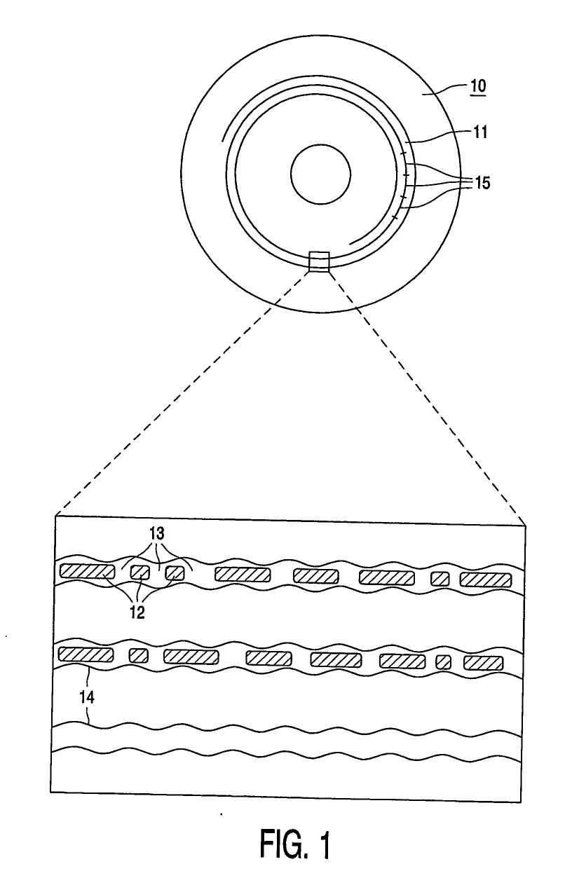

FIG. 1 shows an embodiment of the information carrier according to the invention,

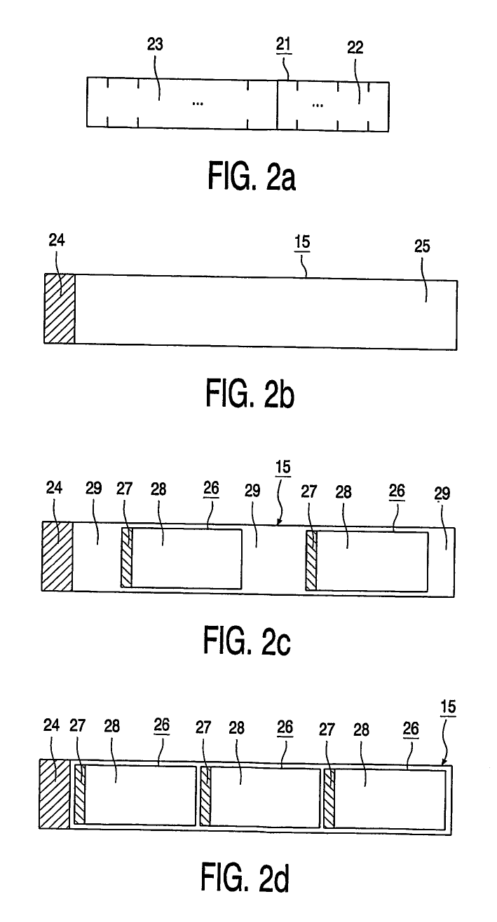

FIG. 2a shows a position information present on a position information frame shown in FIG. 1, in the form of a word,

FIG. 2b shows a position information frame present on an information carrier according to the prior art,

FIGS. 2c, 2d show embodiments of a position information frame present on the information carrier shown in FIG. 1,

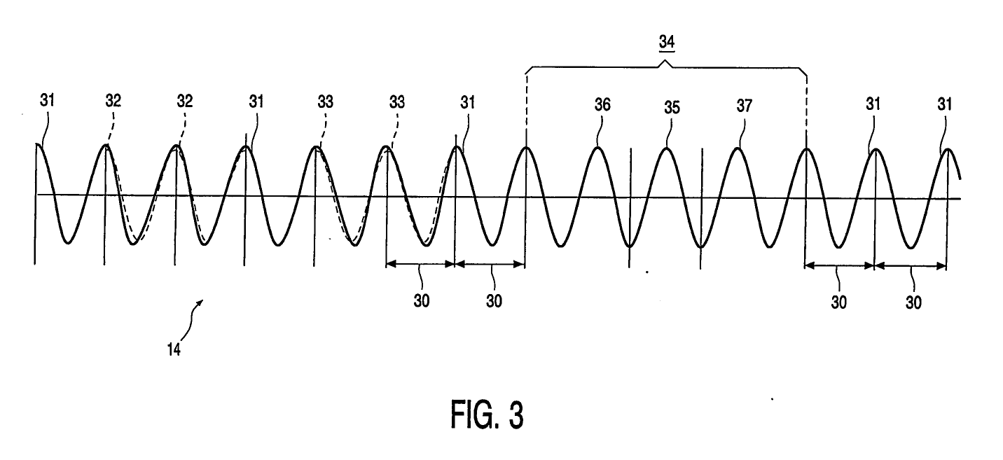

FIG. 3 shows the features of the wobble modulation according to BD,

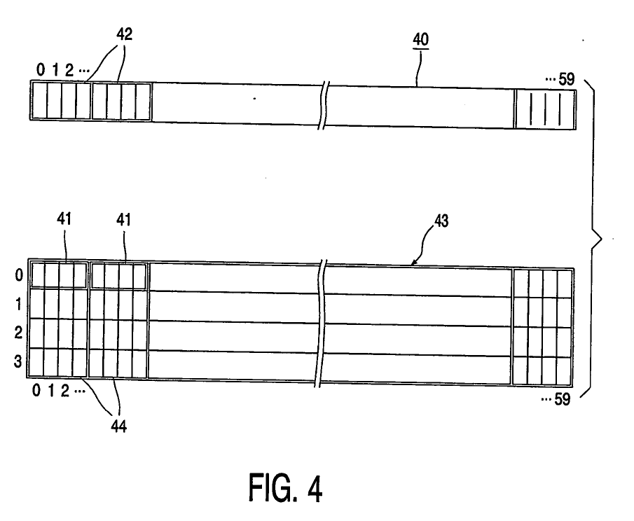

FIG. 4 shows the allocation of the available information bits in a position information frame according to an embodiment of the invention,

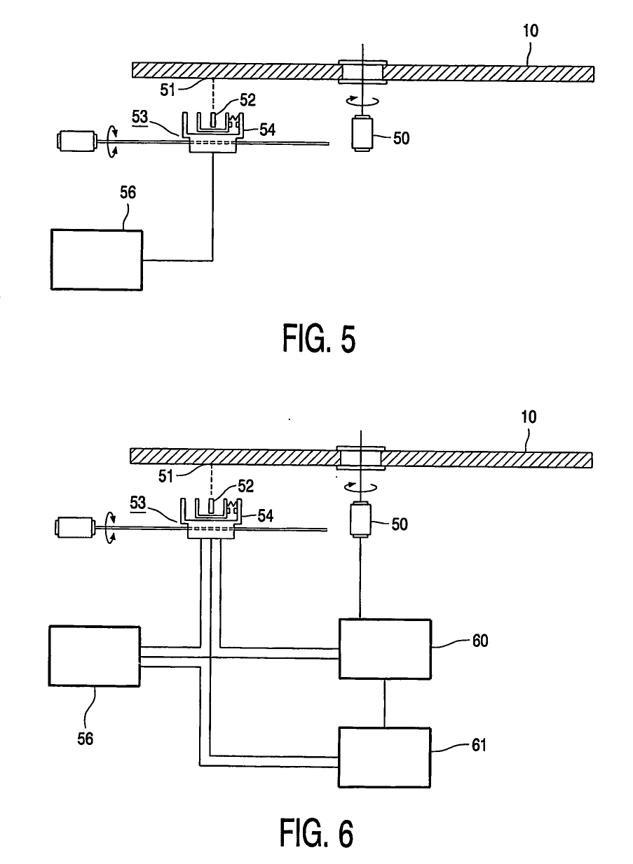

FIG. 5 shows an embodiment of the apparatus according to the invention,

FIG. 6 shows a further embodiment of the apparatus according to the invention,

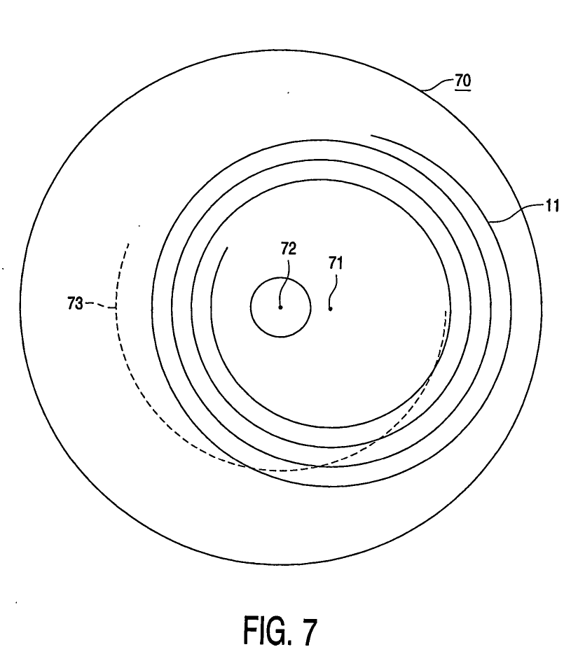

FIG. 7 shows, for the understanding of the phenomenon of radial run-out, an optical disk upon rotation of which a radial run-out occurs.

FIG. 1 shows an embodiment of the information carrier according to the invention.

The information carrier 10 comprises two physically distinct channels: a main channel, mainly used for comprising user-information, e.g. music, a movie, software or other user-data, and an auxiliary channel comprising position information frames 15 necessary for accessing the information carrier 10.

In the example in FIG. 1, the information carrier 10 is an optical disk of recordable type having a spiral shaped groove 11. In the main channel, if any information has been recorded, the information is present in the form of a succession of zones characterized by a relatively lower reflectivity interleaved by zones characterized by a relatively higher reflectivity, also known respectively as pits 12 and lands 13. In the auxiliary channel the information is present in the form of a radial modulation of the groove 11, also known as wobble modulation 14.

If any user-information is contained in the optical disk, this information is divided in data blocks arranged sequentially along the groove, each data block occupying a distinct and predefined segment of the groove, not shown in the Figure, and each segment having a distinct address, the segments representing a first partition of the groove. When user-information is written onto the optical disk, data blocks carrying the user-information have to be prepared and assigned in advance to a respective address, and have to be written into the predefined segments of the groove having the respective address.

The auxiliary channel, which has a capacity significantly lower than the main channel, contains pre-recorded control information and cannot be modified by the user. Similarly to the main channel, also the information contained in the auxiliary channel is organized in a sequence of frames occupying distinct segments of the groove, which segments represent a second partition of the groove, not necessarily corresponding to the first partition. Most of the frames are position information frames, which contain position information indicative of their own position on the disk, whereas other frames may contain other information like for example access control information or indicative values of the recording parameters. Therefore, also the frames have an address, i.e. the address of a data block in the main channel which segment shares the same position along the groove as the segment relevant to the frame, independently of whether the frame carries its own address or not; further, the address is not necessarily a distinct address for each frame, since there can be more than one frame overlapping the segment relevant to the same data block: for example on a CD-R each position information frame has a distinct address, whereas on a Blu-ray Disk (BD) groups of three adjacent position information frames have the same address.

FIG. 2a shows a position information present on a position information frame shown in FIG. 1, in the form of a word. The word represents the position information 21 present in a position information frame 15, which position information 21 comprises local position information 22. The position information 21 can be the address of the position information frame 15. Moreover, in the latter case the address can be seen as partitioned into a Least Significant Portion (LSP) and a Most Significant Portion (MSP), the local-position information 22 being the LSP of the address, and the part of the position information which is not included in the local-position information, labeled here for convenience non-local-position information 23, being the MSP of the address. As an alternative, on a disk where a spiral shaped groove having turns is present, and each turn is identified by a progressive turn number, also known in the art as “track number”, the position information 21 present in a position information frame 15 could be represented by the turn number of the turn wherein the relevant segment is located. However, even further alternatives for the position information 21 are possible as combinations of the address and the turn number.

For reference, FIG. 2b shows a position information frame present on an information carrier according to the prior art. The position information frame present on an information carrier according to the prior art comprises a first sync symbol 24 and data symbols 25 indicative of the position information 21. A sync symbol present in a frame has the function to signal to decoding means suitable for acquiring the frame the presence and the position of the frame and to synchronize its acquisition. In alternative, the function of the sync symbol can be accomplished also by a sequence of repeated instances of the same sync symbol, by a sequence of different sync symbols or a combination thereof, or by a particular sequence of data symbols, the particular sequence being of reserved use. The position information 21 is encoded according to an encoding rule, so that some redundancy is introduced for the purpose of error correction or error detection. The encoded version of the position information 21 is reported by the data symbols 25 of the position information frame. Further data symbols not related to the position information 21, not shown in the Figure, may be present in the position information frame.

In contrast with FIG. 2b, FIG. 2c shows an embodiment of a position information frame present on the information carrier shown in FIG. 1. The position information frame 15 comprises a first sync symbol 24 and subframes 26, each having a second sync symbol 27, different from the first sync symbol 24, and data symbols 28 indicative of the local-position information 22. Residual data symbols 29 which are present in the position information frame 15, but not belonging to any subframe 26, are indicative of the complete position information 21, or at least of the non-local-position information 23, the position information frame 15 as a whole being still carrying the complete position information 21, like according to the prior art. There is no requirement for the subframes 26 to carry only the local-position information 22, nor to be equal one to another.

The presence of subframes 26 for carrying repetitions of the local-position information 22 is advantageous but not essential. An alternative could be, for example, an information carrier having position information frames 15 in which the local-position information 22 is repeated at pre-defined distances from the beginning and/or from the end of the position information frames 15.

Preferably the subframes 26 are evenly distributed within the position information frames 15, so as to minimize the portion of position information frame 15 that has to be scanned in order to acquire a subframe 26, and consequently retrieve the local-position information 22. For example, with two subframes 26 per position information frame 15 evenly distributed, it will be necessary to scan at most approximately a half position information frame 15 in order to meet and acquire a subframe 26, and consequently the local-position information 22, in contrast with the necessity to scan at most two position information frames in order to acquire the position information 21 in a known information carrier.

A further advantageous effect can be obtained if a higher number of subframes 26 is present in a position information frame, preferably 5 or more, and even more preferably 10 or more.

FIG. 2d shows another embodiment of a position information frame present on the information carrier according to the invention, wherein, in contrast with FIG. 2c, subframes 26 exhaustively occupy the position information frame 15, i.e. no data symbols are present in the frame, which are not part of any subframe, indicated with 29 in FIG. 2c.

In this case the position information 21, or at least of the non-local-position information 22 can be further partitioned in sub-portions, and each sub-portion can be assigned to one or more subframes 26, so that from all the subframes 26 belonging to a position information frame 15 the complete position information 21 can be reconstructed, and thus retrieved when the entire position information frame 15 is acquired.

In FIGS. 2c and 2d the frames are schematically depicted as having the same length as the fame in FIG. 2b. In fact, a position information 15 frame having repetitions of the local-position information 21, like in an information carrier according to the invention, does not need to physically occupy a longer segment than the corresponding position information without repetitions of the local-position information, like in a known information carrier, i.e. a information carrier according to the prior art. There are several ways in which a position information frame having repetitions can be designed to this end.

First, assuming that the position information in the known information carrier is encoded according to an encoding rule that introduces some redundancy for the purpose of error detection and/or error correction, it is possible to use a different, more efficient, encoding rule, so that less symbols are used for the position information, and to use the exceeding symbols for repetitions of the local-position information.

Second, assuming that information other than the position information is present in a position information frame in the known information carrier, it is possible to remove such information, so that, again, less symbols are used.

Third, it is possible to use a different class of symbols characterized by having a shorter physical length than the symbols present in the known information carrier, for example by having a shorter typical wobble period, so that the symbols occupy a shorter segment, and to use the exceeding length to introduce additional symbols, available for repetitions of the local-position information.

Fourth and particularly interesting, it is possible to redefine the class of symbols to which symbols constituting the position information frame belong, in order to make available a higher number of data symbols. As it is known from the information theory, it is possible to carry at most ln₂N bits of information per every symbol belonging to an alphabet of N symbols. Therefore, if for example the class of symbols is redefined in order to comprise a double number of data symbols, then each data symbol will carry one additional bit of information. In this way the same amount of information can be carried by a lower number of symbols, making it possible that the exceeding symbols are used for some subframes.

The several methods enunciated above can also be used in combination. However, advantages of the invention can be appreciated even when the insertion of subframes having a repetition of the local-position information lead to an overall longer position information frame, since the local-position information can still be made available at a comparably higher rate than in an existing information carrier.

FIG. 3 shows the features of the wobble modulation according to BD.

The wobble modulation 14 has a typical period 30. Each period can have as shape a sinusoid called “monotone” 31, a pseudo-sinusoidal shape called “sawtooth 1” 32, a different pseudo-sinusoidal shape called “sawtooth 0” 33, or belong to an “MSK mark” 34, which is a sequence as long as three typical periods formed by a sinusoid 35 having opposite phase than the in the monotone 31, comprised between two periods having a sinusoidal modulation of a higher frequency indicated with 36 and 37. The wobble modulation is thus used to store information in the form of sequences of symbols.

According to BD, a class of symbols, also known as ADIP units, is defined, where each symbol has a length of 56 typical periods and distinctively combines periods shaped as monotone, sawtooth 1, or sawtooth 0, and MSK marks. MSK marks represent a form of low level sync symbols, not to be confused with the sync symbols of the frame, for the identification of the symbols.

The following table lists the symbol types according to BD and their pattern. In this table a first column labeled “symbol type” lists the symbols present in the class of symbols, and a second column labeled “pattern” indicates the pattern corresponding to a symbol by means of a string wherein each character of the string indicates a typical period 30, and in particular the character “-” represents a monotone 31, “1” represents a sawtooth 1 32, “0” represents a sawtooth 0 33, and the three-characters substring “MSK” represents an MSK mark 34.

| | |
|---|---|
| symbol type | pattern |

| | |
|---|---|
| monotone | MSK----------------------------------------------------- |
| reference | MSK---------------0000000000000000000000000000000000000- |
| sync_0 | MSK-------------MSK-------MSK--------------------------- |
| sync_1 | MSK---------------MSK-------MSK------------------------- |
| sync_2 | MSK-----------------MSK-------MSK----------------------- |
| sync_3 | MSK-------------------MSK-------MSK--------------------- |
| data_0 | MSK-----------MSK-0000000000000000000000000000000000000- |
| data_1 | MSK---------MSK---1111111111111111111111111111111111111- |

The class of symbols comprises only two symbol types defining data symbols, data_{—}0 and data_{—}1, therefore each data symbol can carry 1 bit of information, whereas the other symbols are for the synchronization of decoding means charged of the acquisition of the frames.

In an embodiment of the information carrier according to the invention, the wobble modulation 14 has a typical period 30, and the groove 11 comprises portions having length of one typical period 30 and “monotone” 31 shape, and portions having length of three typical periods and being shaped as “MSK mark” 34, as according to Blu-ray Disk format, and the position information frames 15 are formed by symbols belonging to a class of symbols having length of 56 typical periods and having a distinctive pattern, formed by a combination of “monotone” and “MSK marks” as specified in the following table, wherein a first column labeled “symbol type” lists the symbols present in the class of symbols, and a second column labeled “pattern” indicates the pattern corresponding to a symbol by means of a string wherein each character of the string indicates a typical period 30, and in particular the character “-” represents a monotone 31, and the three-characters substring “MSK” represents an MSK mark 34.

| | |
|---|---|
| symbol type | pattern |

| | |
|---|---|
| monotone | MSK----------------------------------------------------- |
| sync_0 | --------------------MSK---MSK---MSK--------------------- |
| sync_1 | --------------MSK-------MSK-------MSK------------------- |
| data_0 | --------MSK---------------MSK---------------MSK--------- |
| data_1 | ----------------MSK-MSK-MSK----------------------------- |
| data_2 | ----------MSK-----MSK-------------MSK------------------- |
| data_3 | --------------MSK---------------MSK--------------------- |
| data_4 | ------------MSK-------------MSK-----------MSK----------- |
| data_5 | --------------MSK-MSK---------------MSK----------------- |
| data_6 | ------------MSK-----MSK---------------MSK--------------- |
| data_7 | ----------------------MSK-MSK-----------MSK------------- |
| data_8 | --------MSK-------------MSK--------------MSK------------ |
| data_9 | ----------MSK-------------MSK------------MSK------------ |
| data_10 | ----------------MSK---------------MSK-MSK--------------- |
| data_11 | ------------MSK-----------MSK-----MSK------------------- |
| data_12 | ----------MSK-----------MSK-MSK------------------------- |
| data_13 | ------------MSK---------------MSK-----------MSK--------- |
| data_14 | --------------------MSK-------------MSK-----MSK--------- |
| data_15 | --------MSK-----------MSK------------MSK---------------- |

In respect with the BD standard, it can be noticed that a symbol or ADIP unit still consist of 56 typical periods of the wobble modulation, but the class of symbols comprises 16 distinct data symbols, data_{—}0 to data_{—}15, so that each data symbol can carry 4 channel bits. Period shaped as “sawtooth 1” or “sawtooth 0” are no longer used.

This definition of the class of symbols, which is subject-matter of non pre-published European Patent Application 03076488.0 (=PHNL030606 EPQ), has the advantage of augmenting the number of available data symbols from 2, like in an existing BD, to 16, like according to the invention. In this way the number of bits of information carried by each data symbols is augmented from 1 to 4. Since according to this embodiment each data symbol carries more bits of information than as according BD, there will be a number of bits in excess for carrying repetitions of the local-position information, while keeping the same length of a position information frame as it is according to BD, which is 83 symbols.

Starting from the symbols, or ADIP units, frames are formed as sequences of symbols.

According to BD, frames of the auxiliary channel, also known as ADIP frames, consist of 83 symbols and have a structure as specified in the following table. In this table, a first column labeled “position” has numbers from 1 to 83 indicating a position, and a second column labeled “symbol type” indicates what symbol type is present in the respective position, wherein “data symbol” indicates any of the symbol type data_{—}0, data_{—}1.

| position | symbol type |
|---|---|
| 1 | monotone |
| 2 | sync_0 |
| 3 | monotone |
| 4 | sync_1 |
| 5 | monotone |
| 6 | sync_2 |
| 7 | monotone |
| 8 | sync_3 |
| 9 | reference |
| 10 | data symbol |
| 11 | data symbol |
| 12 | data symbol |
| 13 | data symbol |
| 14 | reference |
| 15 | data symbol |
| 16 | data symbol |
| 16 | data symbol |
| 17 | data symbol |
| . . . | . . . |
| . . . | . . . |
| . . . | . . . |
| 79 | reference |
| 80 | data symbol |
| 81 | data symbol |
| 82 | data symbol |
| 83 | data symbol |

It can be noticed that a frame accounts for 60 data symbols, carrying 60 channel bits, since each data symbol can carry channel 1 bit.

From these 60 bits, after decoding and error correction, 36 control bits are extracted.

According to BD, data blocks present in the main channel, which are also known as ECC blocks and have a size of 64 Kbytes, are identified by an address consisting of 24 bits. Therefore the 36 control bits carried by a position information frame comprise the 24 bits of the address word, and 12 bits for reserved use. There are 3 ADIP frames per ECC block.

In a further embodiment of the information carrier according to the invention, the position information frames 15 are formed by the symbols defined in the previously discussed embodiment, consist of 83 symbols, and comprise 15 subframes 26 consisting of 5 symbols each The structure of the position information frames 15 is further specified in the table below, wherein a first column labeled “position” has numbers from 1 to 83 indicating a position, a second column labeled “symbol type” indicates what symbol type is present in the respective position, wherein “data symbol” indicates any of the symbol type data_{—}0 to data_{—}15, and a third column labeled “subframe” indicates if and to what subframe the symbol present in the respective position belongs.

| position | symbol type | symbol type |
|---|---|---|
| 1 | sync_1 | monotone |
| 2 | sync_1 | sync_0 |
| 3 | sync_1 | monotone |
| 4 | monotone | sync_1 |
| 5 | sync_1 | monotone |
| 6 | monotone | sync_2 |
| 7 | monotone | monotone |
| 8 | sync_1 | sync_3 |
| 9 | sync_2 | subframe 1 |
| 10 | data symbol | |
| 11 | data symbol | |
| 12 | data symbol | |
| 13 | data symbol | |
| 14 | sync_2 | subframe 2 |
| 15 | data symbol | |
| 16 | data symbol | |
| 16 | data symbol | |
| 17 | data symbol | |
| . . . | . . . | . . . |
| . . . | . . . | . . . |
| . . . | . . . | . . . |
| 79 | sync_2 | subframe 15 |
| 80 | data symbol | |
| 81 | data symbol | |
| 82 | data symbol | |
| 83 | data symbol | |

It can be noticed that a frame still accounts for 60 data symbols, but this time as many channel bits are carried, since each data symbol can carry 4 channel bits.

FIG. 4 shows a possible allocation of the information bits, which are made n a position information frame according to the latter embodiment of the invention.

A table 43 of 4 rows×60 columns represents the 240 channel bits carried by a position information frame 15. The table 43 can be seen as obtained by the juxtaposition of 15 sub-tables 44 of 4×4 bits each, wherein a sub-table represents the 16 bits present in an individual subframe 26. In each sub-table 44 a group of four bits 41 is allocated to carry portions of four channel bits 42 of the 60 channel bits as according to BD indicated for reference in the Figure as a string 40.

The remaining 12 bits present in each sub-table are allocated to carry the local-position information, and in a sub-embodiment they are used:

6 bits, for the 6 least significant bits of the address, as the LSP of the address;

6 bits, to give more accurate information, for example to indicate the position within the ECC block.

In an alternative sub-embodiment the remaining 12 bits are used:

8 bits, for the 8 least significant bits of the turn number, as the LSP of the turn number;

4 bits, to give more accurate information, for example to indicate the sector on a disc divided as a pie in sectors.

Encoding of the local-position information carried by the subframe can be dispensed with, since a way to validate the local-position information, which is now available at a rate 15 times higher that on the known BD, could be simply to read it two or three times.

It is clear moreover that, the number of bits chosen as the LSP of the address or LSP of the turn number may be different, that another form of more accurate information may be present, or that the 12 bits available may be used entirely for the LSP of the address or LSP of the turn number.

According to a preferred embodiment therefore, the information carrier is an optical disk which maintains most of the features from BD. In particular, ADIP frames still consist of 83 symbols, 8 of which form a sync sequence, as synch symbol for the overall position information frame. However, the remaining 75 are assigned to 15 subframes of 5 symbols each. Each subframe comprises a sync symbol and 4 data symbols, and therefore is carrying 16 channel bits. Four of these bits are used to carry 4 of the original 60 channel bits constituting the information carried by the ADIP frame in the known BD, the 4 bits in each of the 15 subframes accounting for exactly 60 bits. The remaining 12 bits present in each subframe are used to carry the local-position information, which is represented in a sub-embodiment by the LSP of the address, whereas in an alternative sub-embodiment it is represented by the LSP of the turn number.

FIG. 5 shows an embodiment of the apparatus according to the invention

The apparatus comprises read-out means 52 for being positioned on a position on the information carrier 10 in presence thereof, and decoding means 56 to retrieve the position information 21 from the position information frames 15 present in the auxiliary channel of the information carrier 10. The decoding means 56 are able to separately retrieve a repetition of local-position information 22 from position information frames 15 in which the local-position information 22, which is part of the position information 21, is repeatedly present

According to the example in the Figure, the information carrier 10 is an optical disk, as explained in reference with FIG. 1, and therefore the read-out means 52 consist of a laser for producing a laser spot 51 on the optical disk. In this case the optical disk is accessed by means of an optical beam generated by the laser and therefore the position of the read out means 52 on the optical disk, must be intended as the position of the laser spot 51 produced on the optical disk by the laser. Further, the apparatus comprises rotation means 50 to rotate the disk, positioning means 53 to radially position the laser spot on the disk, tracking means 54, as part of the positioning means 53, to keep the laser spot on the groove 11 while the disk is being rotated.

Such an apparatus can determine the position of the read-out means 52 as soon as the local-position information 22 is retrieved, without having to acquire an entire position information frame 15, provided that an estimate of the position of the read-out means 52 is available.

The availability of an estimate of the position of the read-out means 52 may be restricted to predetermined cases, like for example the cases in which positioning means 53 have remained substantially still since the previous access took place, which position is known to the apparatus.

The apparatus accesses the disk by producing a laser spot on it, keeping the laser spot on the groove while rotating it, and therefore scanning the groove, detecting the light reflected from the disk generating from it a first electrical signal relevant to the main channel and a second electrical signal relevant to the auxiliary channel, and feeding these electrical signals to a decoding block which retrieves the information present in the disk.

The electrical signal relevant to the main channel, called HF-signal, is derived from the different light reflectivity of pits 12 and lands 13 that are met by the laser spot while scanning the groove 11, whereas the electrical signal relevant to the auxiliary channel, called wobble signal, at the same time is derived from the wobble modulation 14 of the groove 11.

The apparatus can acknowledge the position of the laser spot on the disk by reading the address present in a position information frame. If the laser spot is positioned in a portion of groove having user-information recorded thereon, the apparatus can also acknowledge the position of the laser spot on the disk by acquiring a data block, since a replica of the address is also present in each data block. During a write access therefore the position information can be retrieved only from a position information frame, whereas during a read access the position information can be retrieved also from the main channel and considerations of convenience will dictate where the position information is actually retrieved from, according to the conditions.

The apparatus does not need to access the disk sequentially from the beginning to the end of the groove but can “jump” towards a desired address, by means of a radial positioning of the laser. However, once the laser spot is on the groove, the access can be only sequential.

An access at a desired “target” address, from an arbitrary current position on the disk is preceded by a seek, during which the laser spot is moved to the target address. The seek procedure usually comprises the following steps:

acknowledging current position of the laser spot, for example by retrieving the current address from a position information frame;

if the current address coincides with the target address the procedure ends, otherwise it continues with the following steps:

calculating on the basis of the target address and of the current address a radial movement for the positioning means to radially position the laser spot;

performing the radial movement and restarting from the first step.

Unless current address and target address coincide from the beginning, two or more iterations of the steps described above will be necessary before the seek is accomplished. Typically three iteration are required. Therefore it is of great advantage that the step of acknowledging current position of the laser spot can be speeded up as according to the invention.

FIG. 6 shows a further embodiment of the apparatus according to the invention, according to which discriminations means 61 are present, for assessing whether the position information 21 can be determined by using the local-position information 22. In an apparatus like the one displayed in the Figure, the set of circumstances in which the position information can be determined on the basis of the estimate of the position of the read-out means and the local-position information need not to be restricted to predetermined cases, as explained in reference with FIG. 5. The discriminations means 61 may function as follows: after start-up several jumps are done and it is assessed by observation under what threshold of the jump length the position information 21 can be correctly determined by using the local-position information 22. This threshold is stored, and during normal operation, following a jump having a length smaller than the threshold, an estimate in made available, allowing in this way the determination of position information 21 by using the local-position information 22.

In the Figure calculation means 60, able to calculate a variation of the position of the read-out means 52 upon rotation of the disk, are also present. The estimate of the position of the read-out means 52 can then be compensated on the basis of said variation.

In an even further an preferred embodiment, the calculation means 60 are able to calculate a variation of the position of the read-out means 52 in presence of a radial run-out upon rotation of the disk. After drive start-up, the radial run-out associated to a disk can be observed during one or more revolutions of the disk and stored in a table in a calibration step. Observation of the radial run-out can be done while the read-out means 52 are kept still in respect with the apparatus: in particular, the tracking means 54 do not attempt to keep the laser spot on the groove 11, i.e. the radial servo loop responsible for this functionality is left open. By observing the radial servo loop error signal in this condition, the number of times the laser spot crosses the groove 11 during one revolution or portion of it can be determined. Such information can be stored so that it can be used during normal operation to compensate the variation of the position due to radial run-out, implementing in this way a feed-forward compensation.

For the understanding of the radial run-out phenomenon, in FIG. 7 it is shown a optical disk 70 upon rotation of which a radial run-out may occur, the optical disk 70 having a spiral shaped groove 11, a center of the spiral 71, a center of the optical disk 72 which does not coincide with the center of the spiral 71. The distance between the center of the spiral 71 and the center of the optical disk 72 has been exaggerated in the Figure for a better understanding. Assuming for convenience that once the optical disk 70 is loaded into an apparatus for accessing the optical disk and rotated by the rotation means 50 the center of rotation would coincide with the center of the optical disk 72, a possible trace 73 of the laser spot on the optical disk 70 while this is being rotated is displayed. The trace 73, which is a portion of circumference centered on the center of the optical disk 72, crosses the groove 11 several times.

Such a trace would be followed by the laser spot in a condition in which the tracking means 54 do not attempt to keep the laser spot on the groove 11, i.e. the radial servo loop is open, introducing uncertainty on the current position upon rotation of the optical disk even when the read-out means have been kept still since the last access, which position is known.

Such a situation could arise for example if the laser has been switched off since previous access for the purpose of power saving. The calculation means 60 provides remedy to this effect, by calculating a variation of the position with which the estimate of the position of the read-out means 52 can be compensated, in order to take into account the effect of the radial run-out.

Although the invention has been elucidated with reference to an information carrier, and in particular to an optical disk, and an apparatus for accessing such an information carrier, it will be evident that other embodiments may be alternatively used to achieve the same object. The scope of the invention is therefore not limited to the embodiments described above, but can also be applied to other kinds of information carriers or to the transmission of information.

It must further be noted that the term “comprises/comprising” when used in this specification, including the claims, is taken to specify the presence of stated features, integers, steps or components, but does not exclude the presence or addition of one or more other features, integers, steps, components or groups thereof. It must also be noted that the word “a” or “an” preceding an element in a claim does not exclude the presence of a plurality of such elements. Moreover, any reference signs do not limit the scope of the claims; the invention can be implemented by means of both hardware and software, and several “means” may be represented by the same item of hardware. Furthermore, the invention resides in each and every novel feature or combination of features.

The invention can be summarized as follows. The invention relates to an information carrier comprising a main channel and an auxiliary channel carrying position information, according to which some of the least significant bits of the position information are made available as local-position information at a higher rate than the whole position information. The information carrier can be in particular an optical disk of recordable type, wherein the auxiliary channel is the wobble channel and the position information is an address. An embodiment of the invention is described of an optical disc based on Blue-ray Disk standard. When an estimate of the current address is already available and the uncertainty only resides in some of the least significant bits, the entire address can be quickly reconstructed as soon as a repetition of the local-position information is acquired.

The invention further relates to an apparatus for accessing such an information carrier.

1. An information carrier (10) comprising a main channel for comprising user information and an auxiliary channel comprising position information frames (15) carrying position information (21), the position information (21) comprising local-position information (22), and the local-position information (22) being repeatedly present in the position information frames (15).

2. An information carrier (10) as claimed in claim 1, wherein the position information frames (15) comprise subframes (26) and the local-position information (22) is present in the subframes (26).

3. An information carrier (10) as claimed in claim 2, wherein the subframes (26) are evenly distributed within the position information frames (15).

4. An information carrier (10) as claimed in claim 2, wherein the position information frames (15) comprise a first sync symbol (24), and data symbols (25) indicative of the position information (21), and the subframes (26) comprise a second sync symbol (27), different from the first sync symbol (24), and data symbols (28) indicative of the local-position information (22).

5. An information carrier (10) as claimed in claim 1, wherein the position information (21) comprises an address.

6. An information carrier (10) as claimed in claim 5, wherein the address is partitioned into a most significant portion and a least significant portion, and the local-position information (22) comprises the least significant portion of the address.

7. An information carrier (10) as claimed in claim 1, wherein a spiral shaped groove (11) having turns is present, each turn having a turn number, the turn number being partitioned into a most significant portion and a least significant portion, and the local-position information (22) comprises the least significant portion of the turn number.

8. An information carrier (10) as claimed in claim 1, wherein a groove (11) having a wobble modulation (14) is present, which wobble modulation (14) constitutes the auxiliary channel.

9. An apparatus for accessing an information carrier (10) comprising a main channel for comprising user information and an auxiliary channel comprising position information frames (15), the position information frames (15) carrying position information (21), provided with:
read-out means (52) for being positioned on a position on the information carrier (10) in presence thereof, to access the information carrier (10); and
decoding means (56) to retrieve the position information (21) from the position information frames (15), the decoding means (56) being able to separately retrieve a repetition of local-position information (22) from position information frames (15), in which the local-position information (22), which is part of the position information (21), is repeatedly present.

10. An apparatus as claimed in claim 9, further comprising discriminations means (61) for assessing whether the position information (21) can be determined by using the local-position information (22).

11. An apparatus as claimed in claim 9 being able to access a disk as the information carrier (10) and further comprising rotation means (50) for producing a rotation of the disk, and calculation means (60) for calculating a variation of the position of the read-out means (52) upon rotation of the disk.

12. An apparatus as claimed in claim 11, wherein the calculation means (60) are able to calculate a variation of the position of the read-out means (52) in presence of a radial run-out.
